(19) United States
(12) Patent Application Publication
(10) Pub. No.: US 2016/0377469 A1
(43) Pub. Date: Dec. 29, 2016

(54) Method and Apparatus for Measuring Gas Flow

(71) Applicant: Politecnico Di Milano, Milano (IT)

(72) Inventor: Aronne Teli, Trevioli (IT)

(21) Appl. No.: 15/102,797

(22) PCT Filed: Dec. 5, 2014
(86) PCT No.: PCT/EP2014/076782

§ 371 Date: Jun. 8, 2016

(30) Foreign Application Priority Data
Dec. 9, 2013 (IT) MI2013A002045

(51) Int. Cl. G01F 3/30

(52) U.S. Cl. CPC G01F 3/30

(57) ABSTRACT

There are described a method and an apparatus for measuring gas flow rate and/or volume (such as gas accumulation and consumption) based on the “rate of rise” method, particularly useful in the field of small gas flow rates, that uses a duct immersed in a liquid so as to generate a hydrostatic pressure that allows increase in pressure in a sealed chamber, so as to avoid the use of solenoid valves, producing a particular advantage when a multiple measurement system is required, when a plurality of gas flows are to be measured. The method can be applied advantageously to measure flow rates of gas produced by chemical and/or biological reactions, in particular the Biochemical Methane Potential (BMP) or the Biochemical Hydrogen Potential (BHP). A variant of the method also allows measurement of the Biochemical Oxygen Demand (BOD).

The present invention relates to a method and to an apparatus for measuring gas flow, based on the “rate of rise” methodology. More in particular the invention relates to a method and to an apparatus for measuring gas flow rate (Q_{gas}) and/or gas volume (V_{gas}), such as gas accumulation and consumption, particularly in the field of small gas flow rates. The ability to measure small gas flow rate and small gas volume is relevant in investigations concerning many technological areas, such as the field of chemical and/or biological processes.

In general, the “rate of rise” methodology applied to the measurement of a flow rate of a gas fluid consists in supplying the flow into a closed chamber of known volume. The increase of the number of molecules inside the chamber translates into an increase in pressure and, in the case of a non-isothermal transformation, of temperature. By means of the ideal gas law and the adoption of suitable calculation algorithms, if the increase of the pressure and optionally of the temperature in the chamber over time is known, the flow rate of the gas can be determined, both in terms of volume, in standard conditions (temperature: 273,15 K; pressure: 1000 matm), and of mass.

The “rate of rise” method is characterized by excellent accuracy and is prevalently used as calibration standard. However, it can be used as measurement method applicable to pure gases or mixtures of gases, whose composition can also be variable, provided that the ideal gas law is valid.

According to the prior art, the method is implemented with the aid of solenoid valves, closed during the measurement step (increase of pressure of the chamber) and opened when a maximum pressure value is reached in the chamber, so as to allow the gas to be discharged. Opening of the solenoid valves is automated and managed by means of a suitable control system, which increases the complexity and cost of “rate of rise” apparatus, particularly in the case of the measurements of small gas flow rates and when a multiple measurement system is required, when a plurality of gas flows are to be measured.

U.S. Pat. No. 7,082,826 B2 describes a gas flow rate measurement device that operates according to the “rate of rise” method, and which requires a system of solenoid valves that affect the cost and complexity of the device.

In the field of measurement of small flow rates other devices differing from the “rate of rise” systems are commonly used. For instance, U.S. Pat. No. 5,092,181 describes a method and an apparatus for measuring gas flow rate in which a gas flow is bubbled through a defined path and each single gas bubble is detected and measured by a sensor, for example a photoelectric sensor. When counting bubbles and then measuring the gas flow, the assumption is made that all the bubbles have the same volume. But, the size of the bubbles may vary with the flow velocity and therefore the assumption may cause the gas flow measurements to be inaccurate for not constant flows.

U.S. Pat. No. 2,340,751 describes an apparatus to measure gas flow for continuous measurement belonging to the class of liquid displacement systems, not to the class of “rate of rise” systems. The device of U.S. Pat. No. 2,340,751 comprises a humidifying chamber, a measuring chamber and an annular discharge chamber. The gas is first humidified in the humidified chamber, then is admitted to the measuring chamber and forces the liquid into the annular chamber until the inner level is below the short end of a U-tube. This displacement action rises the level of liquid in the annular chamber to contact an electrode which energizes a recording instrument that registers a unit volume of gas. The presence of two coaxial chambers and of an additional humidifying chamber through which the gas is bubbled, and the need to use electrodes immersed in a liquid, renders this device relatively complex. Also, the electrodes need to be replaced at the end of their life cycle.

Another measuring device working by the principle of liquid displacement is described in WO 2010120229 A1. The device is based on the fact that the gas accumulates in a chamber (cell), with defined physical and active volumes, placed in water bath. The accumulation of gas pivotally displaced the cell from its standby position by the buoyant force exerted by a preset quantity of gas accumulated (active volume). The cells is displaced to a position in which all of the accumulated gas is released and the chamber pivots back to its initial standby position for new receipt and storage of gas during another gas filling cycle. The cell also comprises sensor means provided to generate a signal when the cell is not in standby position, which energizes a recording instrument that registers a unit volume of gas. The pivotally displacement mechanism of the cell may be subjected to fouling and aging, so that the buoyant force and the active volume needed to a complete displacement of the cell may vary along time, resulting in the need of cells replacement.

Regardless of the complexity of the devices commonly used in the field of small gas flow rates (optical bubble counter systems and liquid displacement systems), their measurements are less reliable than manometric measurements.

An object of the present invention is therefore that of reducing the complexity and improving the quality of measurements of prior art devices in the field of small flow rates, by providing a method and an apparatus for measuring gas flow rate based on the “rate of rise” principle, but which are able to avoid the use of solenoid valves or complex mechanized systems, providing a particular advantage if a multiple measurement system is required, in the presence of a plurality of gas flows to be measured.

Another object of the present invention is to provide a method and an apparatus for measuring gas flow rate that can be applied to different technological areas and allow accurate measurement regardless of the composition of the gas.

A first aspect of the invention therefore provides a method for measuring gas flow rate that comprises the introduction or the production of a gas flow in a sealed chamber of volume V maintained at a temperature T, thereby performing a compression step, characterized in that:
a) said gas flow is discharged from said sealed chamber through a duct immersed in a liquid contained in a controlled ejection cell, said duct having a downward portion, at the bottom of which is defined a maximum hydrostatic pressure Δpₘₐₓ for said gas, and an upward portion ending with an open end in correspondence of which is defined a minimum hydrostatic pressure Δpₘᵢₙ for said gas, said open end being arranged below the level of said liquid;
b) said gas flow discharged from said sealed chamber flows through said duct, passes through the bottom at the pressure Δpₘₐₓ and moves to the upward portion so that it is ejected from said open end into said liquid, moves up to the surface of said liquid in the space above the level of said liquid and then moves outside of said ejection cell, so that an ejection step is performed;
c) the absolute pressure p of said chamber is measured over time, said pressure p varying from a minimum pressure, corresponding to Δpₘᵢₙ, to a maximum pressure, corresponding to Δpₘₐₓ of said gas;
d) the volume of gas at standard conditions V_{std} (273.15 K, 1000 matm) accumulated in said sealed chamber, corresponding to the pressure p, is calculated by means of ideal gas law and the gas flow rate Q_{gas} is calculated by carrying out a linear interpolation of the V_{std} data over time t, being the angular coefficient of the linear interpolant an estimate of the flow rate Q_{gas};
e) said steps a), b), c) and d) are repeated a plurality of times generating a series of compression and ejection steps of said gas and a series of values of said parameters of ideal gases equation from which a mean value is obtained, so as to obtain an accurate measurement of said gas flow rate Q_{gas} in the case of a constant flow rate, or to carry out a continuous monitoring, in the case of non-constant flow rate.

Another aspect of the invention provides an apparatus for measuring gas flow rate comprising a sealed chamber of volume V, provided with two holes, one for the introduction and one for the discharge of a gas flow or the same sealed chamber provided with a single hole for the discharge of the gas flow, means for measuring the absolute pressure and temperature and means for controlling the temperature, characterized by comprising:
i. an ejection cell of said gas flow, intended to be partially filled with a liquid;
ii. an ejection duct of said gas flow, connected at one end to said discharge hole of said sealed chamber and having the terminal part adapted to be immersed in said liquid of said ejection cell, said terminal part of said duct being formed with a downward portion and an upward portion and an open end, said open end of the terminal part being adapted to be arranged below the level of said liquid, such that said gas can be ejected from said duct in said liquid.

The sealed chamber in the configuration that provides the single discharge hole also carries out the function of reaction chamber and can represent any reactor in which the gas is produced internally via chemical and/or biological reactions, also in the presence of two phases (gas produced, liquid/reaction medium). It can thus be equipped with specific apparatus, such as mixers; supply/sampling lines of the reagents, and the like.

According to a variant of the invention, the method and the apparatus defined above can be applied to measure the consumption of a gas by chemical and/or biological reactions that take place in the sealed chamber of volume V. In this variant the cell previously defined as ejection cell becomes a controlled flow-back cell of the gas intended to be consumed in these reactions, discharged from an appropriate storage chamber maintained at a constant pressure.

According to this variant, the invention therefore provides a method to measure the consumption of gas flow characterized in that it comprises:
a′) the consumption of a gas flow in a sealed reaction chamber of volume V maintained at a temperature T by a chemical and/or biological reaction which occurs in said chamber, said sealed chamber being connected to a closed flow-back cell in which said gas to be consumed is present, thereby a step of pressure decrease occurs in said flow-back cell resulting from the consumption of the gas in said sealed chamber;
b′) the withdrawal of said gas flow by said flow-back cell from a constant pressure storage chamber and its transfer into said flow-back cell via a duct immersed in a liquid contained in said flow-back cell, said duct having a downward portion, at the bottom of which is defined a maximum negative hydrostatic pressure −Δpₘₐₓ for said gas, and an upward portion ending into an open end in correspondence of which is defined a minimum negative hydrostatic pressure −Δpₘᵢₙ for said gas, said open end being arranged below the level of said liquid;
c′) said gas flow discharged from said sealed chamber flows through said duct, passes the bottom at the negative pressure −Δpₘₐₓ and moves to the upward portion so that it is ejected from said open end into said liquid, moves to the surface of said liquid in the space above the level of said liquid which is in connection with said sealed chamber in which the chemical and/or biological reaction takes place, whereby the starting pressure conditions are re-established.
d′) the absolute pressure p of said sealed chamber is measured over time, said pressure p varying from the pressure corresponding to −Δpₘᵢₙ, to the pressure corresponding to −Δpₘₐₓ of said gas;
e′) the volume of gas at standard conditions V_{std} (273.15 K, 1000 matm) accumulated in the sealed chamber, corresponding to the pressure p, is calculated by means of ideal gas law and the gas flow rate Q_{gas} is calculated by carrying out a linear interpolation of the V_{std} data over time t, being the angular coefficient of the linear interpolant an estimate of the flow rate Q_{gas}
f′) said steps a′), b′), c′), d′) and e′) are repeated a plurality of times to generate a series of steps creating a negative pressure and re-establishing the starting pressure of said gas, and a series of values of said parameters of the ideal gases equation from which a mean value is obtained, so as to obtain an accurate measurement of said gas flow rate Q_{gas} consumed in the case of a constant flow rate, or to carry out a continuous monitoring, in the case of non-constant flow rate.

Another aspect of the variant of the invention consists of an apparatus to measure the consumption of a gas flow by chemical and/or biological reactions that take place in the sealed chamber of volume V.

According to this variant, the apparatus to measure the consumption of a gas flow is characterized in that it comprises:
i′. a sealed reaction chamber of volume V, provided with a hole for the introduction of a gas flow intended to be consumed in a reaction that takes place in said chamber, means for measuring the absolute pressure and temperature and means for adjusting the temperature;
ii′. a flow-back cell of said gas flow, intended to contain a liquid that fills a part of said chamber and defines a volume portion above the level of said liquid adapted to contain said gas, there being mounted in the flow-back cell a flow-back duct of said gas flow, having the terminal part immersed in said liquid and shaped with a downward portion and an upward portion, the open end of which is placed below the level of said liquid, such that said gas can be transferred from said duct into said liquid and from it in said volume above said liquid.
iii′. said flow-back duct being connected at the opposite end to a constant pressure storage chamber for said gas intended to be consumed in said reaction chamber.

The method and the apparatus according to the invention have been found to be particularly advantageous to measure relatively small gas flow rates, preferably below 1 L min⁻¹ (in standard conditions), more preferably below 0.5 L min⁻¹ (in standard conditions). For these flow rate values, the maximum hydrostatic pressure Δpₘₐₓ established in the ejection duct is less than 0.025 atm, preferably less than 0.015 atm. The internal diameter of the ejection duct is preferably less than 25 mm, more preferably less than 10 mm.

According to one aspect of the invention, when the internal diameter of the ejection duct is less than 8 mm, it is preferably made with one or more terminal notches on the open end or close to the open end, in order to allow the re-establishment of the starting conditions of the cycle in a spontaneous way, so as to perform continuous and subsequent steps of compression and ejection.

According to another aspect of the invention, the upward portion and the downward portion of the ejection duct are parallel.

The invention is now described with reference to the accompanying figures, provided for non-limiting illustrative purposes, wherein:

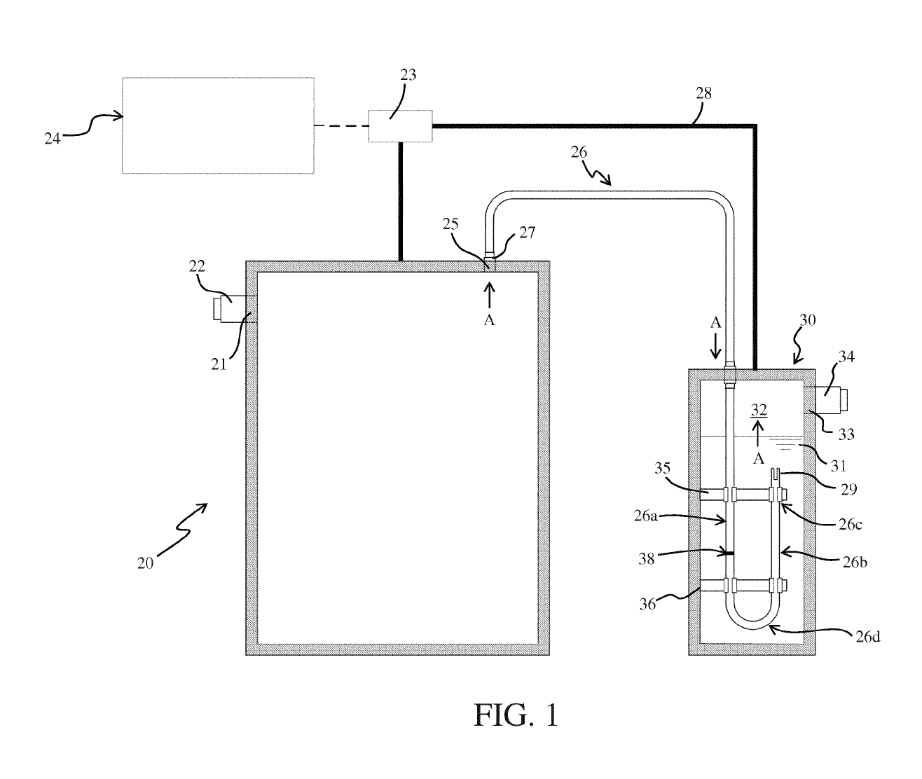

FIG. 1 is a schematic view of an apparatus for implementation of the method for measuring gas flow rate according to the invention;

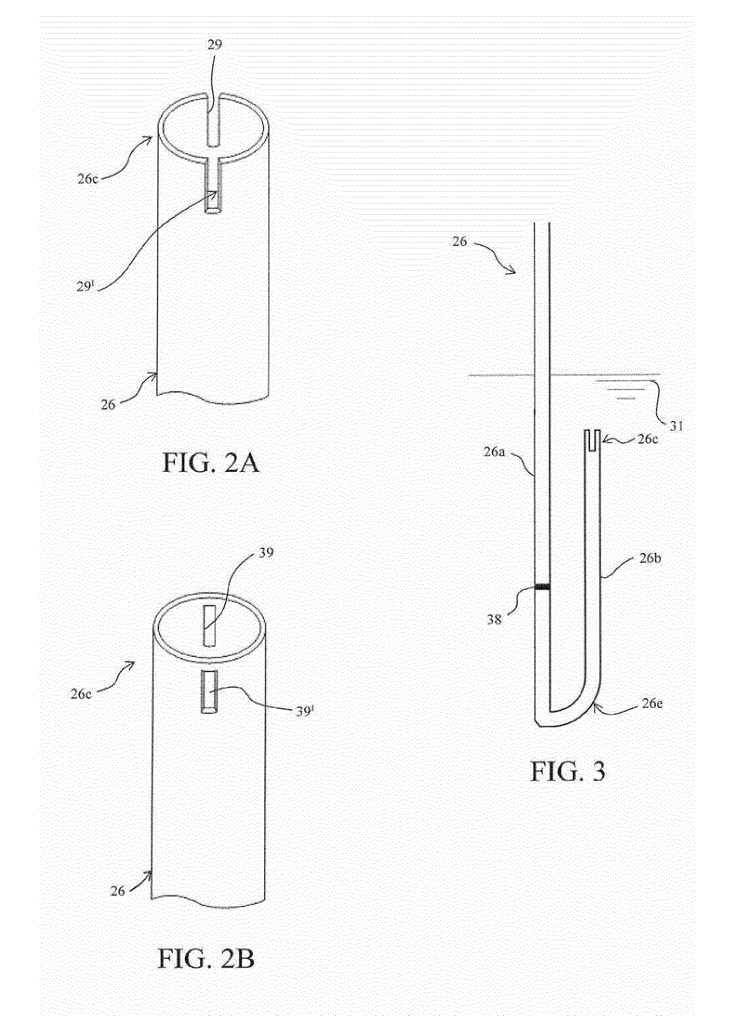

FIGS. 2 and 3 are schematic views of different embodiments of details of the apparatus of FIG. 1;

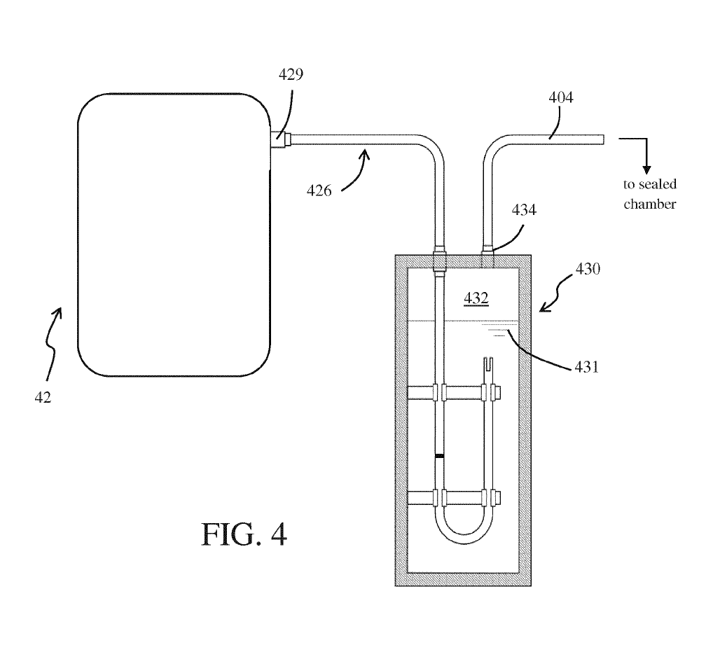

FIG. 4 is a schematic view of an apparatus for implementation of the method to measure the consumption of a gas flow according to a variant of the invention;

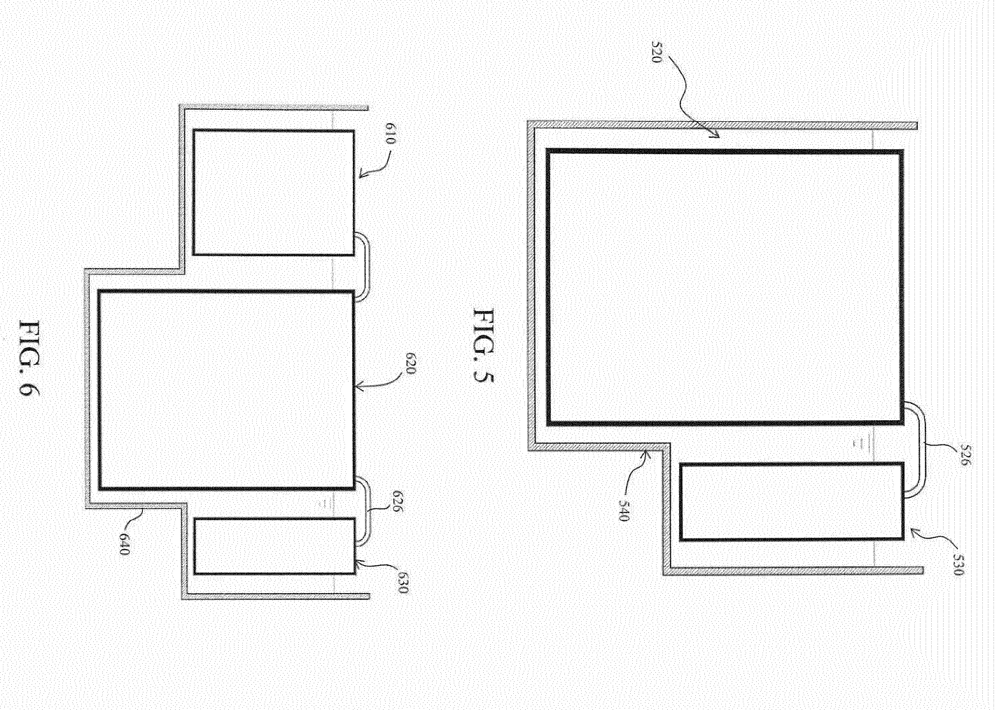

FIGS. 5 and 6 are schematic views of different embodiments of the apparatus of FIG. 1;

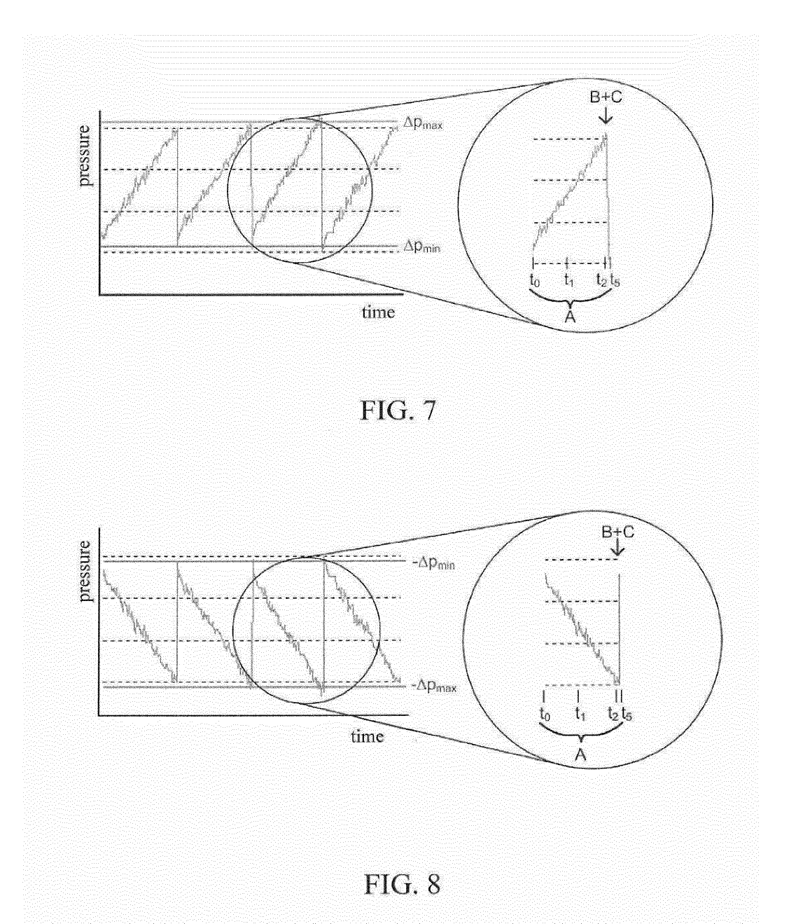

FIG. 7 schematically illustrates the trend of the pressure within the scope of the method and of the apparatus of FIG. 1;

FIG. 8 schematically illustrates the trend of the pressure within the scope of the method and of the apparatus of FIG. 4;

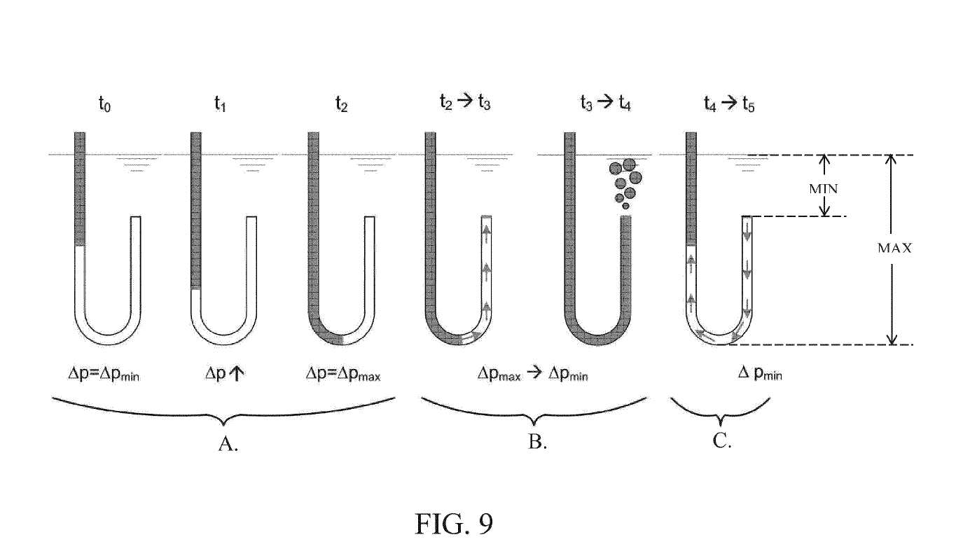

FIG. 9 illustrates operation of the method and of the apparatus of FIG. 1;

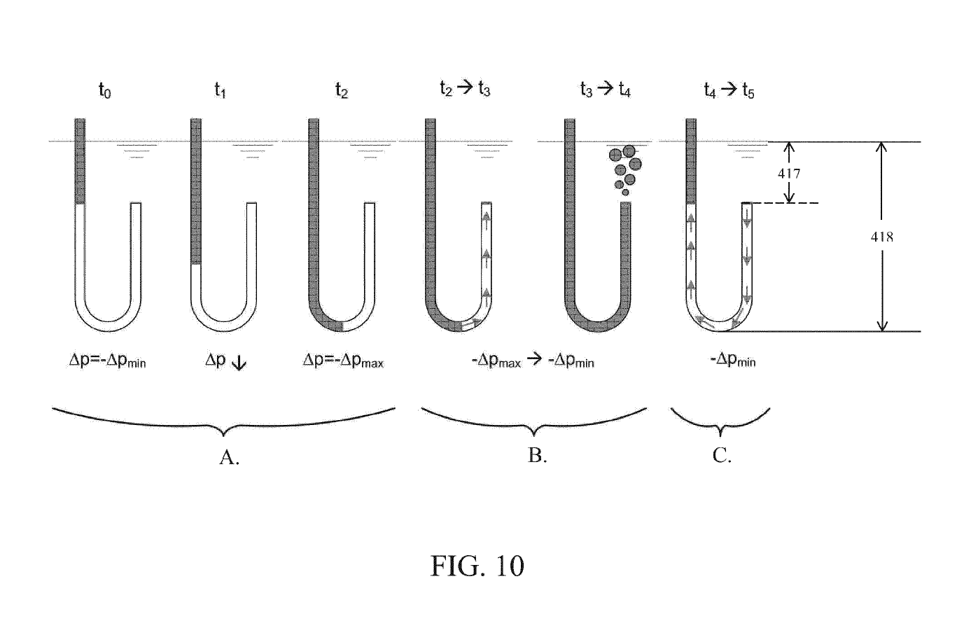

FIG. 10 illustrates operation of the method and of the apparatus of FIG. 4;

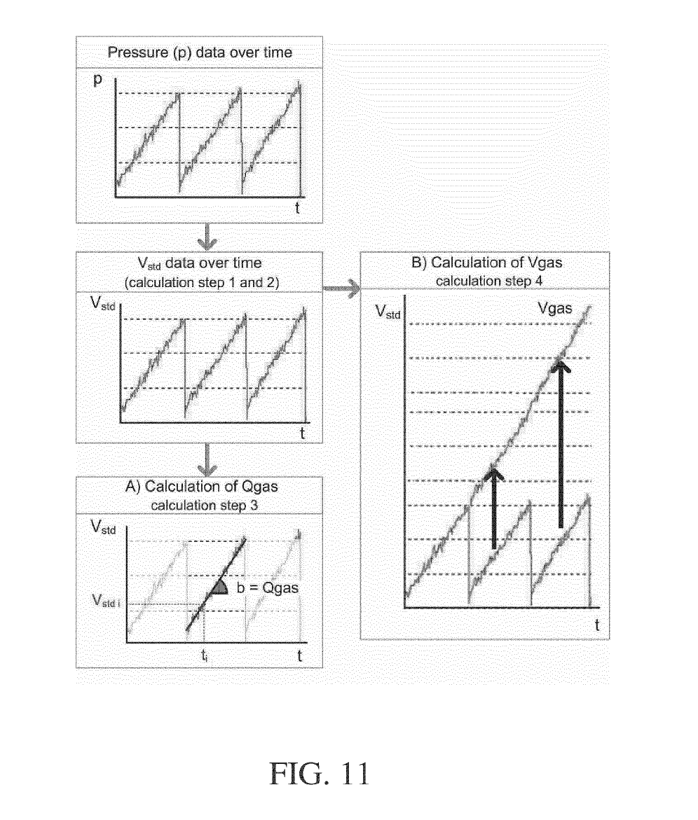

FIG. 11 is a graph relating to the method and to the apparatus of FIG. 1;

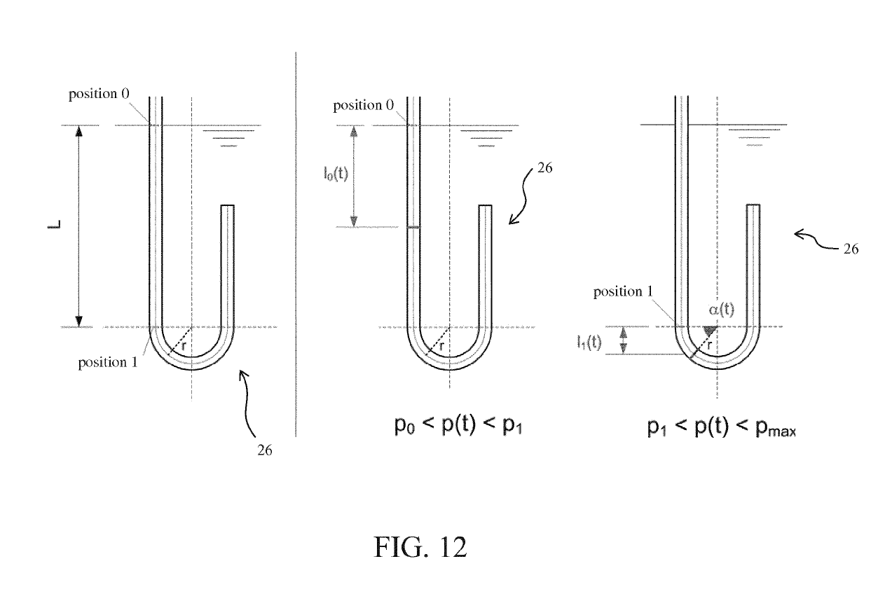

FIG. 12 illustrates a detail of the apparatus according to the invention.

With reference to FIG. 1, the apparatus according to the invention, in the embodiment aimed at measuring gas flow rate, comprises a sealed chamber 20, of known volume V, provided with a hole 21, inserted in which is a connector 22 for introduction of a gas flow at a flow rate Q_{gas} to be measured, which can optionally be provided with a back-pressure regulator, the function of which is to maintain the pressure upstream of the sealed chamber unvaried. The sealed chamber 20 is provided with means 23 for measuring the absolute pressure and the temperature, and means for controlling the temperature, not indicated in the figure, for example consisting of a thermostatic bath or other system known to those skilled in the art.

The means for measuring the absolute pressure and the temperature 23, consisting of suitable sensors, are connected to a control unit 24, which has the function of analyzing and processing the data sent by the means 23 for measuring pressure and temperature and of calculating the gas flow rate Q_{gas}, as will be explained below.

The sealed chamber 20 is also provided with a hole 25 for the discharge of the gas flow in an ejection cell 30 through an ejection duct 26 connected at one end to the hole 25 through a connector 27.

As indicated above, the sealed chamber 20 can also carry out the function of reaction chamber and can represent any reactor in which the gas is produced internally via chemical and/or biological reactions, including in the presence of several phases, for example a liquid and a gas phase, consisting of the gas produced by the reaction. In this case, the reaction chamber is not provided with a hole for introduction of the gas but only with a discharge hole (25), but can be equipped with specific apparatus, such as mixers, supply lines of the reagents, sampling lines and the like.

The ejection cell 30 is filled, for a portion of its volume, with a liquid 31 at known density (d), such as to define a head space 32 above the level of the liquid 31. The terminal part of the ejection duct 26 is immersed in the liquid 31 and is shaped with a first downward portion 26a and second upward portion 26b, the end 26c of which is open and is placed below the level of the liquid 31. The portions 26a and 26b are parallel and are connected between a lower U-shaped portion 26d. In the space 32 above the level of the liquid 31 a hole 33 is provided, mounted in which is a connector 34, through which the gas flow can be transferred outside the measuring apparatus. The sensors 23 are connected through the line 28 with the head space 32 of the ejection cell 30, so as to be able to measure the temperature and the absolute pressure of the same cell.

If the gas discharged from the apparatus through the hole 33 is not conveyed through a system of pipes with significant losses of pressure, the pressure in the head space 32 coincides with the atmospheric pressure. As a result, in these conditions the sensors 23 can be arranged to directly measure the atmospheric pressure.

The first downward portion 26a and the second upward portion 26b of the duct 26 are fixed to the cell 30 by means of brackets 35, 36. The end 26c of the duct 26 terminates with a notch 29, the function of which is to allow re-establishment of the starting conditions of the cycle in a spontaneous way, so as to perform continuous and subsequent steps of compression and ejection.

Using the apparatus described above it is possible to implement the method for measuring the flow rate according to the invention.

The gas introduced or produced in the sealed chamber 20 enters the ejection duct 26 and from this the ejection cell 30, as shown by the arrows A of FIG. 1. The liquid 31 present in the ejection cell has the function of generating a hydrostatic pressure with respect to the atmospheric pressure value. Due to the effect of this pressure, a certain quantity of liquid, for example water, enters the duct 26 through the end 26c counterbalancing the gas pressure established in the sealed chamber 20 and in the duct. A balance is created, highlighted by the positioning of the interface 38 between the gas and the liquid in the downward portion of the ejection duct 26. In this situation, the ejection cell 30 forms a hydraulic closing valve of the sealed chamber 20 (FIG. 9, time to).

With the increase of the quantity of gas introduced (or produced) in the chamber 20, the pressure of the chamber increases and the gas present in the duct 26 pushes back the liquid that entered said duct. This step, called compression, is also highlighted schematically in FIG. 9A, where the gas forms the dark part and the liquid the light part (time t₁). The maximum level of depth of the liquid inside the duct 26 corresponds to a hydrostatic pressure Δpₘₐₓ, and in this case the gas-liquid interface is positioned in the center of the U-shaped part 26d of the duct 26 (time t₂).

When the pressure of the gas in the sealed chamber reaches and exceeds the pressure corresponding to the hydrostatic pressure Δpₘₐₓ the gas ejection step, shown in FIG. 9B, is activated with the gas moving up to the upward portion 26b of the duct 26 (time t₃) until it is effectively ejected from the duct after exceeding the minimum hydrostatic pressure Δpₘᵢₙ (time t₄), in correspondence of the minimum point of depth of the liquid in the duct 26, i.e. at the end of said duct 26c. The maximum and minimum points of depth are represented by the MAX and MIN heights in FIG. 9.

The ejection step is followed by a step to re-establish the starting conditions of the cycle, at which the liquid returns to the duct 26 and returns to the condition in which the gas-liquid interface is in the downward portion 26a of the duct 26 (FIG. 9C, time t₅).

The gas that was ejected from the duct bubbles in the liquid 31 (FIG. 1) and reaches the head space 32, from which it can exit through the hole 33 and the connector 34.

To obtain an accurate measurement of the gas flow rate in the case of flows with constant flow rate, or to carry out a continuous monitoring, in the case of non-constant gas flow rates, a plurality of cycles of steps of compression-ejection-re-establishment, such as the one described above, are carried out. FIG. 7 shows the trend of the pressure (in the ordinate) in time (in the abscissa) for some cycles of compression-ejection-re-establishment, in each of which the pressure rises from a value corresponding to Δpₘᵢₙ to a value corresponding to Δpₘₐₓ to then re-establish the starting conditions, in a time interval t₀-t₅.

The flow rate Q_{gas} (for example in mL min⁻¹ or L h⁻¹ in standard conditions) or the volume of gas produced in the time V_{gas} (for example in mL or L in standard conditions) can be calculated using the ideal gas law as a function of the temperature and absolute pressure data (inside and outside the chamber) measured and recorded by means of the sensors 23 and of the control unit 24, and based on the geometrical characteristics of the components of the apparatus. The calculation method is implemented taking into account the data of pressure p in the compression step A, as follows (FIG. 11):
1. the number of moles n in the sealed chamber 20 at time t are calculated by means of the ideal gas law (1):

$$n = {f}_{H} \cdot \frac{p \cdot {V}^{*}}{R \cdot T} \qquad ( 1 )$$

where:
f_{H}: correction factor that expresses the ratio between moles of dry gas and moles of wet gas (mmol mmol⁻¹), is a function of the water vapor tension at the temperature T (t_{vap T}) and the absolute pressure p:

$${f}_{H} = ( 1 - \frac{{t}_{vap} T}{p} ) \qquad ( 2 )$$

V*: effective volume occupied by the gas at time t, at the effective conditions of temperature T and pressure p, which can be calculated as indicated below;
R: universal gas constant (0.08205784 L matm K⁻¹ mmol⁻¹);
T: temperature inside the sealed chamber 20 (K);
2. the volume of gas at standard conditions V_{std} accumulated during step A in the sealed chamber 20, corresponding to the number of moles n, is calculated by means of ideal gas law:

$${V}_{std} = n \cdot R \cdot \frac{{T}_{std}}{{p}_{std}} = {f}_{H} \cdot {V}^{*} \cdot \frac{p}{T} \cdot \frac{{T}_{std}}{{p}_{std}} \qquad ( 3 )$$

where T_{std} and p_{std} are standard temperature and pressure (273.15 K, 1000 matm)
3. the gas flow rate Q_{gas}, in standard conditions, is computed carrying out a linear interpolation of the data V_{std} over time t taking into account all the data of the compression step A (N data), or for non-constant flow rates, considering smaller interpolation data sets provided that they have an adequate amount of data (N′ data); the flow rate Q_{gas} coincides with the angular coefficient of the linear interpolant.
   An example of linear interpolation is the linear least squares method, a standard approach in mathematics, that can be easily carried out by control unit 24 taking into account the set of N (or N′) data (tᵢ, V_{std i}; i=1, . . . , N or N′) for the linear interpolation. According to the linear least squares methodology the angular coefficient b of the linear interpolant is calculated as follows (FIG. 11A):

$$Qgas = b = \frac{{\sum }_{i = 1}^{N} {t}_{i} \cdot {V}_{std i} - \frac{1}{N} {\sum }_{i = 1}^{N} {t}_{i} {\sum }_{i = 1}^{N} {V}_{std i}}{{\sum }_{i = 1}^{N} {t}_{i}^{2} - \frac{1}{N} {( {\sum }_{i = 1}^{N} {t}_{i} )}^{2}} \qquad ( 4 )$$

4. the gas volume V_{gas}, in standard conditions, produced/accumulated in a given time interval can be carried out by plotting the cumulative curve of V_{std} by vertical translation of the data of the step A of consecutive cycles, as shown schematically in FIG. 11B.
   With regard to the term V* (effective volume occupied by the gas at a generic moment of time, L) introduced in the equation 1, it must be considered as the sum of two components:
a constant component, V₀(L), defined as volume occupied by the gas including the volume of the sealed chamber (20), any volumes upstream at the same pressure, and the volumes inside the ducts (26) up to the position 0 of the gas/liquid interface 38, indicated in FIG. 12, position that is coincident with the level of the liquid 31 (reference to FIG. 1);
a component variable as a function of the effective position of the gas/liquid interface, beyond the position 0, which can be calculated as a function of the geometrical characteristics of the duct 26: length of the portion of vertical duct L (dm), radius of curvature of the curvilinear portion r (dm), and flow passage section s, (dm²).

In order to fully calculate V* the following is defined:
p₀ (matm): absolute pressure corresponding to the gas/liquid interface position 0 (FIG. 12); p₀ corresponds to the atmospheric pressure if the gas delivered from the device is not conveyed through a system of pipes with significant losses of load;
p₁ (matm): absolute pressure corresponding to the gas/liquid interface position 1 (FIG. 12), identified by the flow section of the gas placed between the end of the rectilinear portion and the start of the curvilinear portion of the duct 26. The term p₁ can be calculated as a function of depth between the position 1 and 0 (coincident with L), p₀ and γ, which is the hydrostatic pressure per unit of depth at the temperature of the liquid 31. In the case of water γ=9.66 matm dm⁻¹ at 20° C.; 9.65 matm dm⁻¹ at 25° C.; 9.64 matm dm⁻¹ at 30° C.:

p₁=p₀+L·γ (5)
l₀ (dm): depth of the gas/liquid interface with respect to the position 0, which can be calculated as a function of p, p₀, and γ:

$${l}_{0} = \frac{p - {p}_{0}}{γ} \qquad ( 6 )$$

l₁ (dm); depth of the gas/liquid interface with respect to the position 1, which can be calculated as a function of p(t), p₁, and γ:

$${l}_{1} = \frac{p - {p}_{1}}{γ} \qquad ( 7 )$$

α (radians): angle that expresses the position of the gas/liquid interface with respect to the position 1, as per FIG. 12:

$$α = arcsin ( \frac{{l}_{1}}{r} ) \qquad ( 8 )$$

The volume V* can therefore be calculated through the following equations:

V*=V₀+l₀·s if p₀≦p≦p₁ (9)

V*=V₀+L·s+α·r·s if p>p₁ (10)

If the variable component of V* is completely negligible with respect to the constant component (V₀), V* it can be assumed as coincident with this latter.

As mentioned, the calculation is performed automatically by the control unit 24.

It is evident that the method allows the volumes and the gas flow rates to be measured without the aid of solenoid valves, due to the presence of the ejection duct 26 and of the ejection cell 30.

The system as a whole must be correctly sized so that at each moment of time of the compression step the pressure inside the sealed chamber 20 is counterbalanced by the hydrostatic pressure acting on the gas-liquid interface 38.

Correct sizing of the apparatus, for gas flow rates below 0.5 L min⁻¹ (in standard conditions), is obtained with values of maximum hydrostatic pressure Δpₘₐₓ established in the ejection duct below 0.015 atm. The internal diameter of the ejection duct is preferably below 10 mm. Purely by way of example, Table 1 indicates the preferred values of gas flow rate measurable as a function of some geometrical characteristics of the apparatus, considering distilled water as liquid 31, a temperature of 35° C., atmospheric pressure equal to 1000 matm, a Δpₘᵢₙ value of 1 matm:

TABLE 1
Size characteristics and measurable gas flow rate

| | | | Q_{gas} |
|---|---|---|---|
| V₀ | dᵢ | Δpₘₐₓ | (mL min⁻¹, |
| (L) | (mm) | (matm) | in standard conditions) |
| 0.2 | 2 | 15 | 0-2.5 |
| 0.5 | 2-3 | 15 | 0-6.5 |
| 1 | 2-3 | 15 | 0-12.0 |
| 5 | 4-5 | 15 | 1-55.0 |
| 10 | 6-7 | 15 | 1-113.0 |

where:
V₀ (L): volume occupied by the gas inclusive of the volume of the sealed chamber 20, of any volumes upstream at the same pressure, and the volumes inside the duct 26 up to the level of the liquid 31;
dᵢ(mm): internal diameter of the duct 26;
Δpₘₐₓ: hydrostatic pressure correlated to the maximum depth MAX (FIG. 9);

According to one aspect of the invention, when the internal diameter of the ejection duct is below 8 mm, it is preferably made with one or more terminals notches on the open end or close to the open end, in order to allow the re-establishment of the starting conditions of the cycle in a spontaneous way, so as to perform continuous and subsequent steps of compression and ejection. FIGS. 2A and 2B illustrate the embodiment of the end 26c of the duct 26 provided with notches 29, 29′ that originate starting from this end of the duct (FIG. 2A), and the embodiment provided with notches 39, 39′ made close to the end 26c (FIG. 2B).

In the embodiment of FIG. 1, the ejection duct 26 is produced with the downward portion completely rectilinear and the upward portion connected by a portion of U-shaped, more specifically semi-circular shaped, duct 26d.

According to an alternative embodiment, shown in FIG. 3, the ejection duct 26 is produced with the downward portion 26a completely rectilinear, while the upward portion 26b is connected to the portion 26a through an arc of a circle 26e of 90°. This shape, more complex to produce, has the advantage of simplifying the calculation of the gas flow rate Q_{gas} or of the volume V_{gas}, as calculation of the term V* is based only on the relation 9, due to the fact that the downward portion of the duct is completely rectilinear.

The ejection cell 30 can also be made open. Moreover, it can be equipped with an automated system for maintaining the level of the liquid 31 (not represented FIG. 1), which can in any case also be controlled manually with periodic top-up operations. The frequency of these operations can be reduced by using a filling liquid with low volatility.

The ejection duct 26 can be of any material, geometry, shape, size, and can be composed of a single duct or of several ducts or elements in general, provided it is characterized by:
a maximum level of depth with respect to the level of the liquid present in the cell (MAX level of FIG. 9),
an upward portion of duct (26b),
a gas ejection level placed at a greater height, and therefore with less depth (MIN level of FIG. 9).

As regards to the material of duct 26, glass, metals and rigid or flexible plastic, with particular reference to hoses commonly used in chemical/biological laboratories, can be used.

The sealed chamber 20 can have different shapes and sizes. It can also contain a solution or a selective adsorbent compound to purify or select the compounds present in the gas. Moreover, it can be produced without the hole 21 and the pneumatic connector 22 for introduction; in this case, it can represent any reactor in which the gas is produced internally via chemical and/or biological reactions, including in the presence of two phases (gas produced, liquid/reaction medium). It can thus be equipped with specific apparatus, such as mixers; supply/sampling lines of the reagents, and the like.

A field of application of interest of the present invention is that of the measurement of small or minute flow rates/volumes, for which the apparatus and the method of the invention are particularly advantageous, both due to optimal accuracy and to limited cost. Measurement of small or minute flow rates is relevant in investigations concerning different applications, in particular in the case of biological and/or chemical reactions, for example:

1. laboratory/field scale pilot reactors;

2. apparatus for measuring Biochemical Methane Potential (BMP), Biochemical Hydrogen Potential (BHP) or more generally other gaseous products of chemical and/or biological reactions.

With regard to the application 2, the use of the invention is of particular interest as BMP measurement apparatus available on the market usually allow multiple measurements. Two different configurations, depicted in FIGS. 5 and 6, are possible.

In this application a different embodiment of the invention is produced, in which the sealed chamber can carry out the function of reactor to produce gas and also contain an adsorbent solution/medium as above, as described below.

FIG. 5 shows an apparatus for measuring the biogas (CH₄+CO₂) produced during the test. It consists of the sealed chamber 520 connected to the ejection cell 530 through the duct 526.

The apparatus is placed in a thermostatic bath 540, containing deionized water at the test temperature, generally between 30 and 37° C. Both the chamber 520 and the cell 530 are produced according to the indications of FIG. 1, with the exception of the hole 21 and of the pneumatic connector 22 for introduction, which in the present configuration are absent as the sealed chamber 520 also carries out the function of biological reactor, in which the process gas originates. Consequently, the chamber 520 is partly filled with the reaction mixture/medium (bacterial biomass, organic substrate) and is equipped with a mixing system, with one or more liquid supply/sampling lines (optional) and with one or more gas sampling lines (optional), not illustrated. Different devices can be used for mixing, such as magnetic or mechanical mixers with vertical axis.

Inside the ejection cell 530 it is possible to use a solution H₂SO₄ 0.5% so as to reduce the solubilization of CO₂ in liquid phase and obtain a complete measurement of the biogas produced.

Calculation of the BMP is then implemented based on the production of biogas and measuring the percentage composition of methane in the gas present in the head space of the sealed chamber 520, through suitable analytical techniques, for example through gas-chromatography.

FIG. 6 shows a device that allows only methane CH₄ to be measured. It consists of a biological reactor 610, so that the considerations relating to the chamber 520 apply, with the exception of the fact that the volume of gas is reduced to a minimum, by the sealed chamber 620 and by the ejection cell 630. Both the chamber 620 and the cell 630 are produced according to the indications of FIG. 1 and are connected by the ejection duct 626.

The sealed chamber 620 is partly filled with an alkaline solution (for example, NaOH 3M) with the function of absorbing the CO₂, a compound present in a noteworthy fraction, in addition to the methane in the biogas. Similarly to the previous option, a thermostatic bath 640, similar to 540, is provided. Alternatively to the thermostatic bath, it is possible to use a controlled temperature chamber, in which to place the BMP measurement apparatus.

Both the configurations of FIGS. 5 and 6 are suitable for multiple measurements; in fact, inside the thermostatic bath it is possible to place several devices in parallel, which can be managed by the same control unit, not indicated in FIGS. 5 and 6 but corresponding to the unit 24 of FIG. 1.

As mentioned previously, a variant of the invention relates to a method and an apparatus for measuring the consumption of a gas by chemical and/or biological reactions that take place in the sealed chamber of volume V. In this variant the sealed chamber also carries out the function of reaction chamber or reactor and the cell previously defined as ejection cell becomes a controlled flow-back cell of the gas intended to be consumed in these reactions, discharged from a suitable storage chamber at constant pressure.

The aforesaid variant is illustrated in FIG. 4, in which 42 indicates a storage chamber of a gas intended to be consumed in a reaction that takes place in a sealed reaction chamber, not illustrated but very similar to the sealed chamber 20 of FIG. 1, with suitable means for measuring the absolute pressure and temperature and means for controlling the temperature. It can be equipped with specific apparatus, such as mixers; supply/sampling lines of the reagents, and the like.

Between the storage chamber 42 and the sealed reaction chamber there is placed a controlled flow-back cell 430 of the gas, connected through a flow-back duct 426 to the storage chamber 42. As in the embodiment of FIG. 1, the duct 426 is immersed in a liquid 431 and is shaped and mounted in the same way illustrated in FIG. 1. To simplify the description, no detailed description is provided of the chamber and of its components, in particular of the ejection cell, but instead reference should be made to the description provided above, indicating that the ejection cell assumes the function and the name of controlled flow-back cell.

The flow-back cell 430 operates in cyclic steps of:

(A) reduction of pressure to a value corresponding to the maximum negative pressure (as a function of the difference in level indicated with 418 in FIG. 10);

(B) flow-back of the gas from the outside to the inside of the cell 430, discharged from the storage chamber 42, and subsequent flow-back of the gas, passing through the head space 432, to the sealed reaction chamber;

(C) re-establishing of the starting pressure conditions.

From a structural viewpoint, the cell 430 is similar to the cell 30, with the exception of the following:
the connection with the sealed reaction chamber takes place by means of the connector 434 and the pipe 404; in this way the sealed chamber and the head space of the flow-back cell are connected and, due to correctly sized pipes and volumes of the chamber, are at the same pressure value;
the storage chamber 42 of the gas to be consumed during the reaction is connected to the duct 426 through the connector 429. The storage chamber 42 is at atmospheric pressure, and can therefore be a gas sampling bag or a closed chamber with adequate system for controlling and maintaining constant the pressure.

As shown in FIG. 10, in this configuration the levels of depth of the duct 426 determine the interval of the negative pressure values in which the apparatus operates in the pressure decrease step (step A), i.e. the minimum negative pressure, −Δpₘᵢₙ, as a function of the depth indicated with 417 in FIG. 10 and the maximum negative pressure, −Δpₘₐₓ, as a function of the maximum depth 418. Beyond this negative pressure value, the gas flow-back step (step B) is activated first in the head space 432 of the cell 430 and subsequently in the sealed reaction chamber, rapidly rebalancing the pressure, which returns toward the starting value of −Δpₘᵢₙ (step C).

FIG. 8 shows the trend of the pressure (in the ordinate) in time (in the abscissa) for some cycles of pressure decrease, gas flow-back, re-establishment, in each of which the pressure decrease from a value corresponding to −Δpₘᵢₙ to a value corresponding to −Δpₘₐₓ to then re-establish the starting conditions, in a time interval t₀-t₅.

The control unit 24 of FIG. 1 is also present in the variant of embodiment of FIG. 4, albeit not illustrated. It was represented in FIG. 1 in the form of a block diagram, as it can consist of any electronic device capable of carrying out the function of implementation of the calculation algorithms mentioned previously, of storing the data and optionally of controlling the temperature of the thermostatic bath/cell. For example, these devices can be microprocessors or personal computers with suitable control software. These latter are the type most suitable due to the greater versatility and possible development of software functions that make it more user-friendly. Moreover, the control unit 24 must allow a plurality of devices to be managed if, in the presence of a plurality of gas flows, a multiple measurement system is to be implemented.

The system for measuring the BMP of FIG. 6 is suitable for respirometric measurement of the BOD (Biochemical Oxygen Demand), parameter of interest in the field of aerobic biological processes to treat wastewaters. The ejection cell can in fact be configured as flow-back cell of FIG. 4. Moreover, the storage chamber must be filled with gas 100% O₂.

Although some embodiments and variants of the invention have been described, it is naturally susceptible to other modifications and variants within the scope of the same inventive concept, as defined in the appended claims.

1-17. (canceled)

18. A method for measuring a gas flow rate of a gas introduced in a sealed chamber having a volume maintained at a temperature, the method comprising:
(a) discharging a gas flow from said sealed chamber through a duct immersed in a liquid contained in an ejection cell, said duct having a downward portion, a maximum hydrostatic pressure defined for said gas at a bottom of the downward portion, and an upward portion with an open end, a minimum hydrostatic pressure defined for said gas in correspondence with the open end of the upward portion, said open end being placed below a level of said liquid;
(b) after step (a), passing the gas flow through the bottom of the downward portion at the maximum hydrostatic pressure and moving the gas flow to the upward portion such that the gas flow is ejected from said open end into said liquid, moving the gas flow up to a surface of said liquid into the space above the level of said liquid and then moving the gas flow outside of said ejection cell;
(c) measuring an absolute pressure of said sealed chamber over time, said absolute pressure varying from a minimum pressure, corresponding to the minimum hydrostatic pressure to a maximum pressure, corresponding to the maximum hydrostatic pressure of said gas;
(d) calculating a volume of the gas at standard conditions accumulated in said sealed chamber, corresponding to the absolute pressure, with an ideal gas law equation and calculating the gas flow rate by carrying out a linear interpolation of the volume of gas at standard conditions over time, an angular coefficient of a linear interpolant being an estimate of the gas flow rate; and
(e) repeating steps (a), (b), (c) and (d) a plurality of times, thereby generating a series of compression and ejection steps of said gas and a series of values of parameters of ideal gases equations, obtaining a mean value from the series of values of parameters, such that an accurate measurement of said gas flow rate is obtained in a case of a constant flow rate, or such that a continuous monitoring is carried out in a case of a non-constant flow rate.

19. The method according to claim 18, wherein gas flow rates below 1 L/min in standard conditions are measured.

20. The method according to claim 18, wherein gas flow rates below 0.5 L/min in standard conditions are measured.

21. The method according to claim 18, wherein said maximum hydrostatic pressure in said duct is less than 0.025 atm.

22. The method according to claim 18, wherein said maximum hydrostatic pressure in said duct is less than 0.015 atm.

23. The method according to claim 18, wherein the gas introduced in the sealed chamber is produced in the sealed chamber by at least one of a chemical reaction and a biological reaction.

24. The method according to claim 18, further comprising measuring a biochemical potential of methane production or a biochemical potential of hydrogen production.

25. The method according to claim 18, further comprising measuring a biochemical oxygen demand of a sample.

26. A gas flow rate measurement apparatus comprising:
a sealed chamber having a volume, the sealed chamber defining a discharge hole for discharge of a gas flow;
an ejection cell of said gas flow, the ejection cell configured to be partially filled with a liquid;
an ejection duct of said gas flow, connected by one end to said discharge hole of said sealed chamber and having an end portion configured to be immersed in said liquid of said ejection cell, said end portion of said duct shaped with a downward portion and an upward portion with an open end, said open end located below a level of said liquid, whereby said gas flow may be ejected through said duct in said liquid;
pressure and temperature sensors configured to detect an absolute pressure and a temperature in at least one of the sealed chamber and the ejection cell; and
a temperature-controlled section at least partially surrounding one or more of the sealed chamber and the ejection cell.

27. The apparatus according to claim 26, wherein said sealed chamber is provided with two holes, a first hole for the introduction of a gas flow and a second hole for the discharge of the gas flow.

28. The apparatus according to claim 26, wherein said sealed chamber is provided with a single hole for the discharge of the gas flow, the sealed chamber being a reaction chamber within which said gas flow is produced by chemical and/or biological reactions.

29. The apparatus according to claim 28, wherein:
one or more of the sealed chamber and the ejection cell are placed in a thermostatic bath or in a controlled temperature chamber; and
the sealed chamber is equipped with a mixing system.

30. The apparatus according to claim 29, wherein at least one of a supply line of reagents and a sample line of product gas is connected to the sealed chamber.

31. The apparatus according to claim 26, wherein said downward portion and said upward portion of said ejection duct are parallel.

32. The apparatus according to claim 26, wherein an internal diameter of said ejection duct is less than 25 mm.

33. The apparatus according to claim 26, wherein an internal diameter of said ejection duct is less than 10 mm.

34. The apparatus according to claim 26, wherein said ejection duct is made with one or more terminals notches on said open end or in the proximity of said open end, the terminal notches configured to allow re-establishment of starting conditions of a cycle in a spontaneous way, whereby continuous and subsequent steps of compression and ejection are performed.

35. The apparatus according to claim 26, further comprising:
a biological reactor connected to said chamber by a duct;
at least one sensor configured to measure a biochemical potential of methane production in the a head space of the sealed chamber; and
wherein the temperature-controlled section includes a thermostatic bath or a temperature controlled chamber.

36. The apparatus according to claim 35, wherein said sealed chamber is partially filled with an alkaline solution with a CO₂ absorbing function, and said biological reactor is equipped with a mixing system.

37. The apparatus according to claim 36, wherein said biological reactor is further equipped with one or more supply/sampling lines of at least one of reagents and product gas.

38. A method to measure consumption of a gas, the method comprising:
(a) consuming a gas flow in a sealed reaction chamber, the chamber including a volume maintained at a temperature, by at least one of a chemical reaction and a biological reaction taking place in said chamber, said sealed chamber being connected to a closed flow-back cell in which said gas to be consumed is present, such that decreasing a pressure in said flow-back cell occurs resulting from the consumption of the gas in said sealed chamber;
(b) withdrawing said gas flow by said flow-back cell from a constant pressure storage chamber and transferring the gas flow into said flow-back cell via a duct immersed in a liquid contained in said flow-back cell, said duct having a downward portion, a maximum negative hydrostatic pressure for said gas defined at a bottom of the downward portion, and an upward portion ending with an open end, a minimum negative hydrostatic pressure for said gas defined in correspondence with the open end, said open end being placed below a level of said liquid;
(c) discharging said gas flow from said storage chamber through said duct, the gas flow passing the bottom of the downward portion at the maximum negative hydrostatic pressure and moving to the upward portion such that the gas flow is ejected from said open end into said liquid, the gas flow moving to a surface of said liquid and into a space above the level of said liquid, the space in connection with said sealed chamber in which the at least one of the chemical reaction and the biological reaction takes place, such that the starting pressure conditions are re-established;
(d) measuring an absolute pressure of said sealed chamber over time, said absolute pressure varying from a minimum pressure corresponding to the minimum negative hydrostatic pressure, to a maximum pressure, corresponding to the maximum negative hydrostatic pressure of said gas;
(e) calculating a volume of gas at standard conditions accumulated in the sealed chamber, corresponding to the absolute pressure, with an ideal gas law equation and calculating a gas flow rate by carrying out a linear interpolation of the volume of gas at standard conditions over time, an angular coefficient of a linear interpolant being an estimate of the gas flow rate; and
(f) repeating steps (a), (b), (c), (d) and (e) a plurality of times to generate a series of steps creating a negative pressure and re-establishing a starting pressure of said gas, and creating a series of values of parameters of the ideal gas law equation from which a mean value is obtained, such that an accurate measurement of said gas flow rate is obtained in the case of a constant flow rate, or such that a continuous monitoring is carried out in the case of a non-constant flow rate.

39. A gas flow measurement apparatus for measuring consumption of a gas by at least one of a chemical reaction and a biological reaction, the gas flow measurement apparatus comprising:
a sealed reaction chamber including a volume and a hole defined in the sealed reaction chamber for introduction of a gas flow to be consumed in said sealed reaction chamber;
a flow-back cell of said gas flow, the flow-back cell configured to contain a liquid which fills a part of said cell and a volume portion defined above a level of said liquid, the volume portion configured to contain said gas and in connection with said sealed reaction chamber;
a flow-back duct mounted in said flow-back cell, the flow-back duct having a terminal part immersed in said liquid and shaped with a downward portion and an upward portion, an open end of the flow-back duct placed below the level of said liquid, whereby said gas can be transferred from said duct into said liquid and from the liquid into said volume portion above said liquid;
said flow-back duct connected at an end opposite the open end to a constant pressure storage chamber containing said gas to be consumed in said sealed reaction chamber;
at least one pressure sensor configured to measure absolute pressure in one or more of the sealed reaction chamber, the flow-back cell, and the storage chamber;
at least one temperature sensor configured to measure temperature in one or more of the sealed reaction chamber, the flow-back cell, and the storage chamber; and
a temperature-controlled section at least partially surrounding one or more of the sealed reaction chamber, the flow-back cell, and the storage chamber.

40. The apparatus according to claim 39, wherein said flow-back duct includes one or more terminals notches defined on the open end or in the proximity of said open end, the terminal notches configured to allow re-establishment of starting conditions of a cycle in a spontaneous way, whereby continuous and subsequent steps of compression and ejection are performed.
